(19) United States
(12) Patent Application Publication
(10) Pub. No.: US 2026/0124843 A1
(43) Pub. Date: May 7, 2026

(54) RECORDING DEVICE AND RECORDING METHOD

(71) Applicant: SEIKO EPSON CORPORATION, Tokyo (JP)

(72) Inventors: Naohiro UEYAMA, MATSUMOTO-SHI (JP); Ryuichi SATO, SHIOJIRI-SHI (JP); Yohei NUNOKAWA, SHIOJIRI-SHI (JP)

(21) Appl. No.: 19/377,463

(22) Filed: Nov. 3, 2025

(30) Foreign Application Priority Data
Nov. 5, 2024 (JP) 2024-193833

(51) Int. Cl. B41J 15/04; B41J 3/407

(52) U.S. Cl. CPC B41J 15/046; B41J 3/4078; B41J 15/048

(57) ABSTRACT

The recording device 1 includes a feeding section 3 that feeds, in a transport direction F, a roll-shaped medium 2, which is formed by attaching a fabric 9 to a support member 8 having an adhesive surface 7, a recording section 4 that performs recording on the medium 2, a pressing section 5 that is located upstream of the recording section 4 in the transport direction F and that nips and presses the medium 2, and an adjustment section 6 that can adjust a pressing force P applied to the medium 2 by the pressing section 5.

The present application is based on, and claims priority from JP Application Serial Number 2024-193833, filed November 5, 2024, the disclosure of which is hereby incorporated by reference herein in its entirety.

### BACKGROUND

### 1. Technical Field

The present disclosure relates to a recording device such as a printer and a recording method.

### 2. Related Art

An example of a related art device of this kind is described in JP-A-2013-6315.

When printing is directly performed on fabric, expansion and contraction are likely to occur, and the fabric is likely to be deformed. As a means for suppressing the expansion and contraction, there is a method of printing by attaching a fabric to an adhesive sheet. However, when the user himself or herself performs the operation of attaching the fabric to the adhesive sheet, the pressing force for attachment varies depending on the user, and it is difficult to always obtain a specified attaching force.

JP-A-2013-6315 discloses an image forming apparatus including an attaching section that attaches a printing substrate (film) fed from a roll to an adhesive surface of a supporting substrate (film) fed from a roll-shaped feeding roll to form a composite substrate.

The specified attaching force varies depending on the affinity between the adhesive of the adhesive surface and the fabric. Therefore, it is necessary to adjust the pressing force by the attaching section according to the type of adhesive and the type of fabric. However, JP-A-2013-6315 does not consider the adjustment of the pressing force at all.

When the fabric is pressed with a force smaller than the specified attaching force, the fabric peels off from the pressure-sensitive adhesive sheet when the fabric passes through a bent path or a section of a transport roller, or when printing is performed by ejecting ink to the fabric, and printing fails. When the fabric is pressed with a force larger than the specified attaching force, the fabric is subjected to a load more than necessary when the fabric is peeled off from the pressure-sensitive adhesive sheet, and the fabric may be damaged.

### SUMMARY

In order to solve the above-described problem, a recording device according to the present disclosure includes a feeding section configured to feed a roll-shaped medium in a transport direction, the roll-shaped medium being formed by attaching a fabric to a support member having an adhesive surface; a recording section configured to perform recording on the medium; a pressing section that is positioned upstream of the recording section in the transport direction and that is configured to nip and press the medium; and an adjustment section configured to adjust pressing force applied to the medium by the pressing section.

A recording method according to the present disclosure includes feeding a roll-shaped medium in a transport direction, the roll-shaped medium including a fabric attached to a support member having an adhesive surface; nipping and pressing, by a pressing section, the medium being fed; adjusting a pressing force applied to the medium by the pressing section according to a type of the medium; and recording on the medium by a recording section at a position downstream of the pressing section in the transport direction.

### BRIEF DESCRIPTION OF THE DRAWINGS

FIG. 1 is a schematic side view of a schematic configuration of a recording device of a first embodiment.

FIG. 2 is an enlarged schematic side view of a main section of the first embodiment.

FIG. 3 is an enlarged perspective view of a main section of the first embodiment.

FIG. 4 is an enlarged schematic side view of a main section of a second embodiment.

FIG. 5 is an enlarged schematic side view of a main section of a second embodiment.

FIG. 6 is an enlarged schematic side view of a main section of a second embodiment.

FIG. 7 is an enlarged schematic plan view of a main section of a second embodiment.

FIG. 8 is an enlarged schematic side view of a main section of a third embodiment.

### DESCRIPTION OF EMBODIMENTS

The present disclosure will be first schematically described below.

In order to solve the above-described problem, a recording device according to a first aspect of the present disclosure includes a feeding section configured to feed a roll-shaped medium in a transport direction, the roll-shaped medium being formed by attaching a fabric to a support member having an adhesive surface; a recording section configured to perform recording on the medium; a pressing section that is positioned upstream of the recording section in the transport direction and that is configured to nip and press the medium; and an adjustment section configured to adjust pressing force applied to the medium by the pressing section.

According to the present aspect, the pressing section is positioned upstream of the recording section in the transport direction, and the pressing section nips and presses the medium. Further, an adjustment section is provided that adjusts pressing force applied to the medium by the pressing section. According to this, the fabric can be easily attached to the support member with a specified attaching force by adjusting the pressing force, regardless of the type of the fabric or the adhesive of the adhesive surface. Therefore, it is possible to reduce a concern that the fabric will be peeled off from the support member during transport of the medium or during execution of recording by the recording section. Damage to the fabric that occurs when the fabric is peeled off from the support member can be suppressed.

A recording device according to a second aspect of the present disclosure is an aspect according to the first aspect, wherein the pressing section includes a drive roller that is coupled to a drive section and that is applied with rotational drive force and a pressing roller configured to rotate in accordance with rotation of the drive roller and the adjustment section includes a spring connected to the pressing roller and a cam configured to adjust length of the spring.

According to the present aspect, the pressing section includes the drive roller that is connected to the drive section and that is applied with rotational drive force, and the pressing roller that rotates in accordance with rotation of the drive roller. The adjustment section includes a spring connected to the pressing roller and a cam that adjusts length of the spring. By this, adjustment of the pressing force by the adjustment section can be realized with a simple structure.

A recording device according to a third aspect of the present disclosure is an aspect according to the second aspect, wherein an elastic member is provided on a surface of the pressing roller.

According to the present aspect the elastic member is provided on a surface of the pressing roller. By this, the elastic member can absorb the influence of the drive roller bending or small unevenness in its surface, and an appropriate pressing force can be applied to the medium.

A recording device according to a fourth aspect of the present disclosure is an aspect that according to the second aspect, wherein the pressing roller includes a group of a plurality of first rollers divided in a width direction that intersects the transport direction of the medium and a group of second rollers that are disposed downstream of the group of first rollers in the transport direction and that are also disposed so as to fill gaps between the first rollers in the width direction and the spring and the cam are connected to each of the group of first rollers and the group of second rollers.

When the pressing roller is configured by a single roller, the roller diameter is increased in order to absorb deflection of the shaft, and thus the size may increase.

According to the present aspect, the pressing roller includes a group of a plurality of first rollers divided in the width direction, which intersects the transport direction of the medium, and a group of second rollers that is disposed downstream of the group of first rollers in the transport direction and that is disposed to fill gaps between the first rollers in the width direction. That is, the pressing rollers are divided into a group of first rollers and a group of second rollers. Further, the spring and the cam are connected to each of the group of first rollers and the group of second rollers. This eliminates the need to increase the roller diameter, thereby suppressing an increase in size.

A recording device according to a fifth aspect of the present disclosure is an aspect according to the first aspect, and further includes a transport roller that is disposed downstream of the pressing section in the transport direction and that transports the medium, wherein the pressing section includes a drive roller that is coupled to a drive section and that is applied with rotational drive force and a pressing roller that is driven to rotate by following movement of the medium nipped by a pair of rollers that include the pressing roller and the drive roller and the adjustment section adjusts pressing force by rotating the drive roller in a reverse transport direction, which is a direction opposite to the transport direction.

According to the present aspect, the transport roller that transports the medium is provided downstream of the pressing section. The pressing section includes a drive roller that is connected to a drive section and that is applied with rotational drive force, and a pressing roller that is driven to rotate by following movement of the medium nipped by the pair of roller that includes the drive roller and the pressing roller. Further, the adjustment section adjusts pressing force by rotating the drive roller in a reverse transport direction, which is a direction opposite to the transport direction. By this, the medium, while in a state of receiving transport force in the transport direction from the transport roller, is in a state of receiving a force from the drive roller directed in the direction opposite to the transport direction, and thus, it is possible to efficiently increase the pressing force. The pressing force can be adjusted by changing the rotation speed of the drive roller in the reverse transport direction.

A recording device according to a sixth aspect of the present disclosure is an aspect according to the fifth aspect, wherein an elastic member is provided on a surface of the drive roller and a low friction material is provided on a surface of the elastic member.

According to the present aspect, an elastic member is provided on the surface of the drive roller, and the surface of the elastic member is provided with low friction material. Since the surface of the drive roller is elastically deformed and presses the medium while in a squashed shape, the surface of the drive roller is not in linear contact with the medium but in surface contact with the medium. By this, the medium is in a state of being rubbed by receiving force from the drive roller in the direction opposite to the transport direction, but the pressing force can be adjusted in a state in which damage to the medium is suppressed by the elastic member and the low friction material.

A recording device according to a seventh aspect of the present disclosure is an aspect according to the fifth aspect, wherein rotation speed of the drive roller is higher than rotation speed of the transport roller.

It should be noted that this aspect may be according to the sixth aspect.

According to the present aspect, the rotation speed of the drive roller is set to be higher than the rotation speed of the transport roller. This makes it possible to efficiently adjust the pressing force.

A recording device according to an eighth aspect of the present disclosure is an aspect according to the fifth aspect, wherein a diameter of the drive roller is larger than a diameter of the transport roller.

It should be noted that this aspect may be according to the sixth aspect or the seventh aspect.

According to the present aspect, the diameter of the drive roller is larger than the diameter of the transport roller. By this, since the diameter is large, it is possible to secure a contact area with respect to the medium and efficiently apply a pressing force.

A recording method according to a ninth aspect of the present disclosure includes feeding a roll-shaped medium in a transport direction, the roll-shaped medium including a fabric attached to a support member having an adhesive surface; nipping and pressing, by a pressing section, the medium being fed; adjusting a pressing force applied to the medium by the pressing section according to a type of the medium; and recording on the medium by a recording section at a position downstream of the pressing section in the transport direction.

According to the present aspect, the same effects as those of the first aspect can be obtained.

### EMBODIMENTS

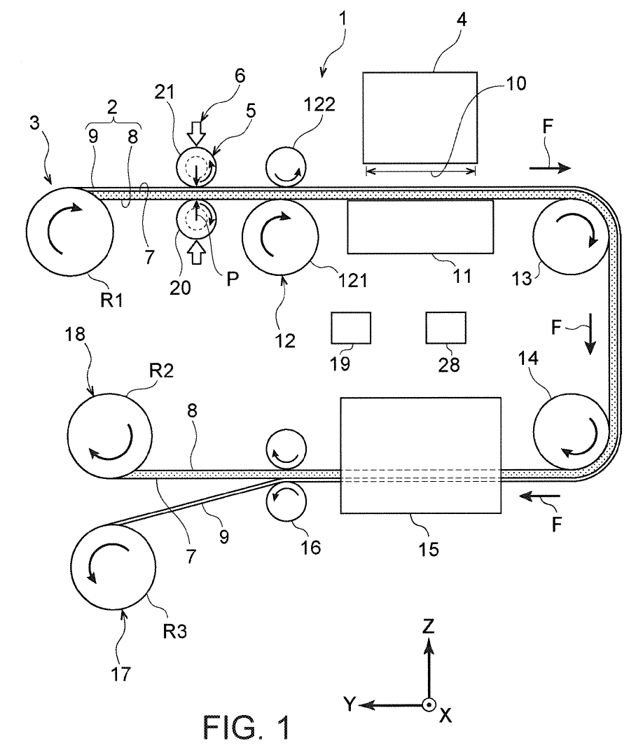

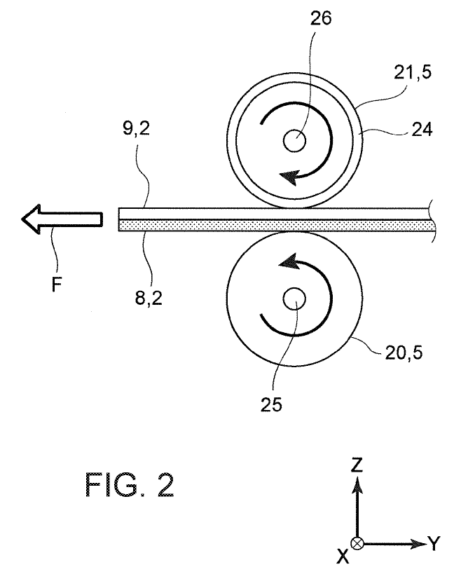

Hereinafter, a recording device and a recording method according to embodiments of the present disclosure will be described in detail with reference to FIGS. 1 to 8. Here, a case where the recording device is an ink jet printer will be described.

In the following description, three axes orthogonal to each other are defined as an X axis, a Y axis, and a Z axis, respectively, as illustrated in the drawings. The directions indicated by the arrows of the three axes (X, Y, Z) are the + directions of the respective directions, and the opposite directions are the - directions. The Z-axis direction corresponds to a vertical direction, that is, a direction in which gravity acts, and the +Z direction indicates a vertically upward direction and the -Z direction indicates a vertically downward direction. The X-axis direction and the Y-axis direction correspond to horizontal directions. The +Y direction indicates the front direction of the recording device, and the -Y direction indicates the rear direction of the recording device. The +X direction indicates the rightward direction of the recording device, and the -X direction indicates the leftward direction of the recording device.

### FIRST EMBODIMENT

The recording device 1 of the present embodiment is an ink jet printer as an example.

As illustrated in FIG. 1, the recording device 1 includes a feeding section 3 that feeds a medium 2 in a transport direction F, a recording section 4, a pressing section 5, and an adjustment section 6.

The medium 2 is a roll-shaped medium in which a sheet-shaped fabric 9 is attached to a sheet-shaped support member 8 having an adhesive surface 7. The medium 2 is set in the feeding section 3 in a state of a roll body R1. The feeding section 3 feeds out the medium 2 in the transport direction F by rotating the roll body R1. The recording section 4 performs recording by ejecting ink onto the fabric 9 of the fed medium 2 in the recording execution region 10. In the recording execution region 10, the medium 2 is supported by a platen 11.

The pressing section 5 is located upstream of the recording section 4 in the transport direction F. The pressing section 5 is configured to nip the medium 2 moving in the transport direction F and to press the medium 2 by applying a pressing force P. The adjustment section 6 is configured to be able to adjust the pressing force P applied to the medium 2 by the pressing section 5. The specific structures of the pressing section 5 and the adjustment section 6 will be described later.

As illustrated in FIG. 1, the recording device 1 further includes a transport section 12 that applies transport force to the medium 2 toward the recording section 4, intermediate rollers 13, 14, a drying process section 15, an end roller pair 16, a fabric winding section 17, and a support member winding section 18.

The transport section 12 is configured by a pair of rollers including a transport roller 121 that rotates by receiving power from a drive source and a pressing roller 122 that rotates by following rotation of the transport roller 121. The intermediate rollers 13, 14 are disposed at positions where the transport direction of the medium 2 changes, and are driven to rotate with movement of the medium 2 in the transport direction F. The drying process section 15 heats and dries the medium 2 onto which the ink was ejected. The end rollers 16 nip the medium 2 and are driven to rotate with movement of the medium 2.

The fabric winding section 17 winds up only the fabric 8 to form a roll body R2. The support member winding section 18 is disposed at a position separated from the fabric winding section 17, and winds up only the support member 9 to form a roll body R3. That is, the medium 2 is configured such that, in a state of being nipped by the end section rollers 16, the fabric winding section 17 winds up only the fabric and the support member winding section 18 winds up only the support member 9, and thus both are peeled away from each other.

### Pressing section and adjustment section

Next, the structures of the pressing section 5 and the adjustment section 6 of the recording device 1 according to the first embodiment will be described with reference to FIGS. 1 to 3.

The pressing section 5 is configured by a pair of rollers including a drive roller 20 and a pressing roller 21. The drive roller 20 is connected to the drive section 19 (FIG. 1) in terms of power and receives a rotational drive force. A motor is used as the drive section 20. The drive roller 20 is integrally attached to a rotation shaft 25. Both ends of the rotation shaft 25 are rotatably supported by a structural member such as a frame (not illustrated). The drive roller 20 rotates integrally with the rotation shaft 25 by the rotation shaft 25 axially rotating by rotational drive force of the drive section 19.

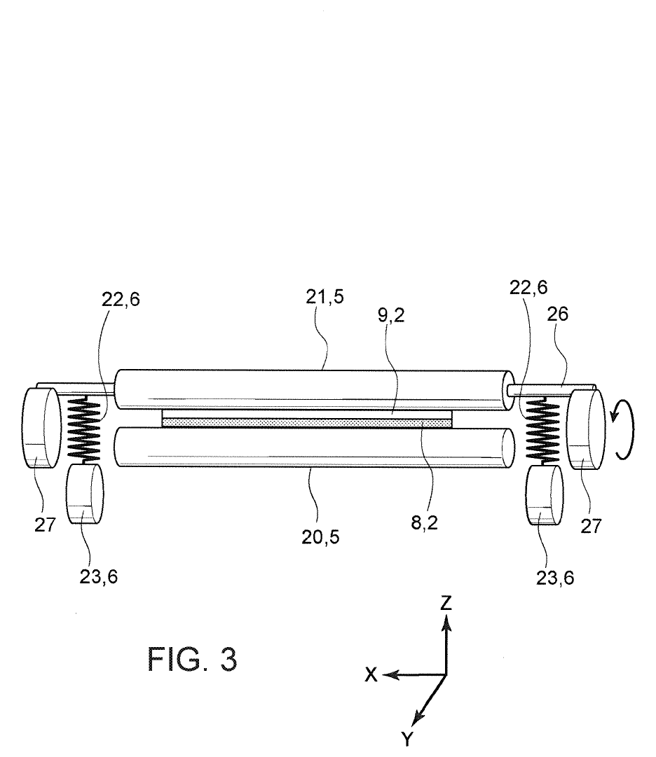

In FIG. 3, the rotation shaft 25 is not illustrated in order to avoid complication of the drawing.

The pressing roller 21 is driven to rotate along with rotation of the drive roller 20. The pressing roller 21 is rotatably attached to a support shaft 26. That is, the pressing roller 21 is configured to rotate with respect to the support shaft 26 by following rotation of the drive roller 20. In other words, the medium 2 that is nipped by the pair of rollers including the pressing roller 21 and the drive roller 20 receives transport force due to rotation of the drive roller 20 and moves in the transport direction F, and the pressing roller 21 rotates following the movement of the medium 2.

In the present embodiment, a release cam 27 is in contact with the support shaft 26. When setting the medium 2 to pass between the drive roller 20 and the pressing roller 21, the release cam 27 is rotated, and thus, it is possible to widen the gap between the drive roller 20 and the pressing roller 21.

In the present embodiment, an elastic member 24 is provided on the surface of the pressing roller 21. The elastic member 24 is made of a rubber material.

In the present embodiment, the adjustment section 6 includes springs 22 connected to the pressing roller 21 and cams 23 that adjust the length of the springs 22.

Specifically, as illustrated in FIG. 3, one end of each spring 22 is fixed to the support shaft 26 of the pressing roller 21, and the other end is fixed to one of the cams 23. The springs 22 are provided in a state of a tension spring, and are configured to pull the pressing roller 21 toward the drive roller 20 to apply the pressing force P to the medium 2. The springs 22 are configured such that the length thereof changes, that is, the pulling force thereof changes, as the cams 23 rotate, and by this the magnitude of the pressing force P can be continuously changed and adjusted.

Both ends of the support shaft 26 are supported by a structural member such as a frame (not illustrated) so as to be movable in a direction in which the pressing force P can be increased or decreased, in order to enable adjustment of the pressing force P.

In the present embodiment, the magnitude of the appropriate pressing force P is grasped and determined in advance by trials or the like for a plurality of types of the medium 2 that are assumed will be used. When a user performs an operation of specifying the type of the medium 2 through an operation panel or the like (not illustrated), the cams 23 rotate, and a corresponding pressing force P acts on the medium 2.

For a new medium 2 that was not supposed would be used, the user performs a trial or changes the rotation state of the cams 23 based on experience, and thus, it is possible to apply a pressing force that is considered to be appropriate for the medium 2.

That is, the pressing force P applied to the medium 2 by the pressing section 5 can be adjusted according to the type of the medium 2.

The operations of the feeding section 3, the pressing section 5, the transport section 12, the recording section 4, the drying process section 15, the fabric winding section 17, and the support member winding section 18 are performed by a control section 28 (FIG. 1). The control section 28 includes a CPU, a flash ROM, and a RAM. The CPU performs various calculation processes according to a program stored in the flash ROM, and controls overall operation of the recording device 1. The flash ROM, which is an example of a storage section, is a readable and writable nonvolatile memory. Various types of information are temporarily stored in the RAM, which is an example of a storage section.

### Feeding, adjustment of pressing force, and execution of recording

In the present embodiment, the recording section 4 performs recording on the medium 2 fed from the feeding section 3 as follows.

First, the feeding section 3 feeds, in the transport direction F, the roll-shaped medium 2 formed by attaching the fabric 9 to the support member 8 having the adhesive surface 7. The pressing section 5 holds and presses the medium 2 to be fed out subsequently. The pressing force P applied to the medium 2 by the pressing section 5 is adjusted by the adjustment section 6 according to the type of the medium 2. Then, the recording section 4 performs recording on the medium 2 at a position downstream of the pressing section 5 in the transport direction F.

### Description of effects of first embodiment

(1) In the present embodiment, the pressing section 5 is located upstream of the recording section 4 in the transport direction F, and the pressing section 5 nips and presses the medium 2. The medium pressing device further includes the adjustment section 6 capable of adjusting the pressing force P applied to the medium 2 by the pressing section 5. By this, by adjusting the pressing force P, the fabric 9 can be easily attached to the support member 8 with a specified attaching force regardless of the type of the fabric 9 or the adhesive of the adhesive surface 7. Therefore, it is possible to reduce the possibility that the fabric 9 peels off from the support member 8 during transport of the medium 2 or during execution of recording by the recording section 4. Damage to the fabric 9 that occurs when the fabric 9 is peeled off from the support member 8 can be suppressed.

(2) In the present embodiment, the pressing section 5 includes the drive roller 20, which is connected to the drive section 19 and to which a rotational drive force is applied, and the pressing roller 21, which rotates with rotation of the drive roller 20. The adjustment section 6 includes springs 22 connected to the pressing roller 21 and cams 23 that adjust the length of the springs 22. By this, adjustment of the pressing force P by the adjustment section 6 can be realized with a simple structure.

(3) In the present embodiment, the elastic member 24 is provided on the surface of the pressing roller 21. By this, the elastic member 24 can absorb the influence of deflection of the drive roller 20 or small unevenness on its surface, and an appropriate pressing force P can be applied to the medium 2.

### SECOND EMBODIMENT

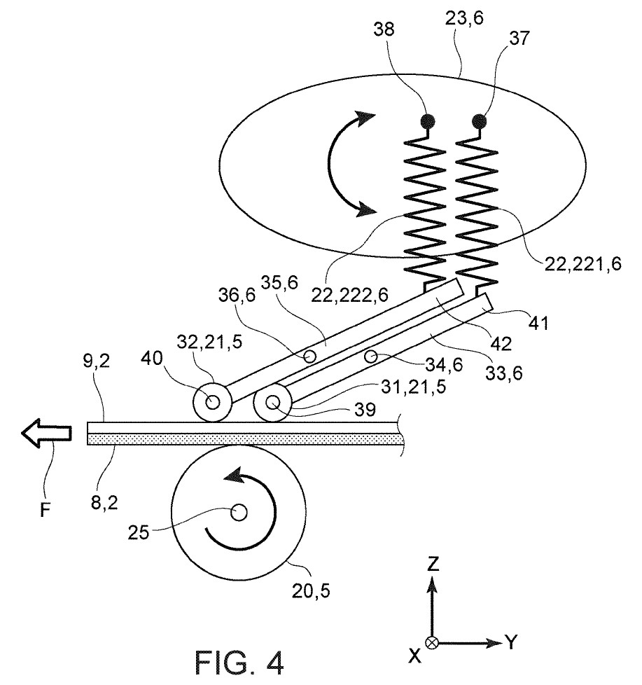

Next, a recording device 1 according to a second embodiment will be described with reference to FIGS. 4 to 7. The same reference numerals are given to the same sections as those of the first embodiment, and description of that configuration and the corresponding effects will be omitted.

In the present embodiment, the pressing roller 21 includes a group of a plurality of first pressing rollers 31, 31... divided in the width direction (X direction), which intersects the transport direction f of the medium 2, and a group of second pressing rollers 32, 32... disposed downstream of the group of the first pressing rollers 31, 31... disposed in the transport direction F and so as to fill the gaps between the first pressing rollers 31 in the width direction (X direction).

The springs 22 and the cams 23 are connected to each of the group of the first pressing rollers 31, 31... and the group of the second pressing rollers 32, 32....

Specifically, the first pressing rollers 31, 31... are rotatably attached to support shafts 39, which corresponds to the support shaft 26 of the first embodiment. The support shafts 39 are attached to one end of swing members 33. The swing members 33 are swingably supported by a swing fulcrum shaft 34. One end of springs 221, which are the springs 22, is connected to the other end of the swing members 33. The other end of springs 221 is connected to the cams 23 at connection point 37. When the cams 23 rotate as indicated by arrows, the length of the springs 221 changes as will be described later, and, by this, the swing members 33 swing and the magnitude of the pressing force P changes.

The second pressing rollers 32, 32... are also rotatably attached to support shafts 40, which correspond to the support shaft 26 of the first embodiment. The support shafts 40 are attached to one end of swing members 35. The swing members 35 are swingably supported by a swing fulcrum shaft 36. One end of springs 222, which are the springs 22, is connected to the other end of the swing members 35. The other end of the springs 222 are connected to cams 23 at a connection point 38. When the cams 23 rotate as indicated by the arrows, the length of the springs 222 changes as will be described later, and, by this, the swing members 35 swing and the magnitude of the pressing force P changes.

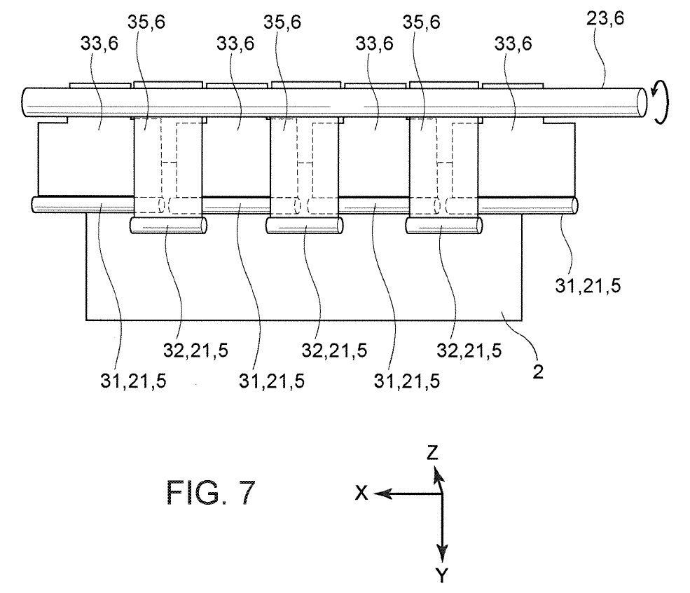

It should be noted that in FIG. 7, the support shafts 39 and the support shafts 40 are not illustrated in order to avoid complication of the drawing. In the present embodiment, the support shafts 39 are provided individually for each of the plurality of first pressing rollers 31, 31.... The support shafts 40 are also provided individually for each of the plurality of second pressing rollers 32, 32....

It should be noted that the support shafts 39 and the support shafts 40 may be configured as a single shaft instead of being separate shafts as described above, and may rotatably support the group of first pressing rollers 31, 31... and the group of second pressing rollers 32, 32... respectively.

### Adjustment of pressing force

In the state illustrated in FIG. 4, tensile forces corresponding to the respective spring lengths of the springs 221 and the springs 222 are applied to the swing members 33 and to the swing members 35. By this, the swing members 33 and the swing members 35 swing with the swing fulcrum shaft 34 and the swing fulcrum shaft 36 acting as swing fulcrums, and the group of the first pressing rollers 31, 31... and the group of the second pressing rollers 32, 32... press the medium 2 with the corresponding pressing forces P.

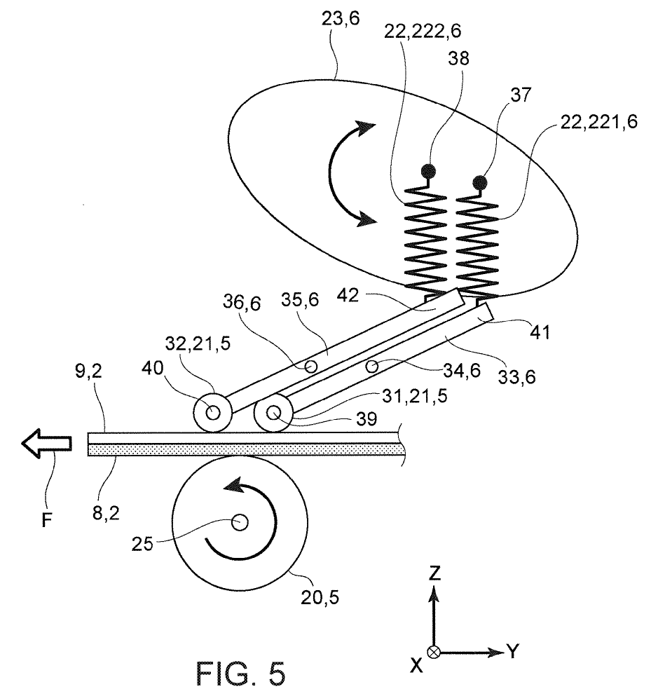

The cams 23 rotate from the state illustrated in FIG. 4 to the state illustrated in FIG. 5. In the state illustrated in FIG. 5, the spring lengths of the springs 221 and the springs 222 are shorter than those in the state illustrated in FIG. 4. This reduces the tensile force applied to the swing members 33 and the swing members 35, and the pressing force corresponding to the group of the first pressing rollers 31, 31... and the group of the second pressing rollers 32, 32... can be adjusted in a direction to be reduced.

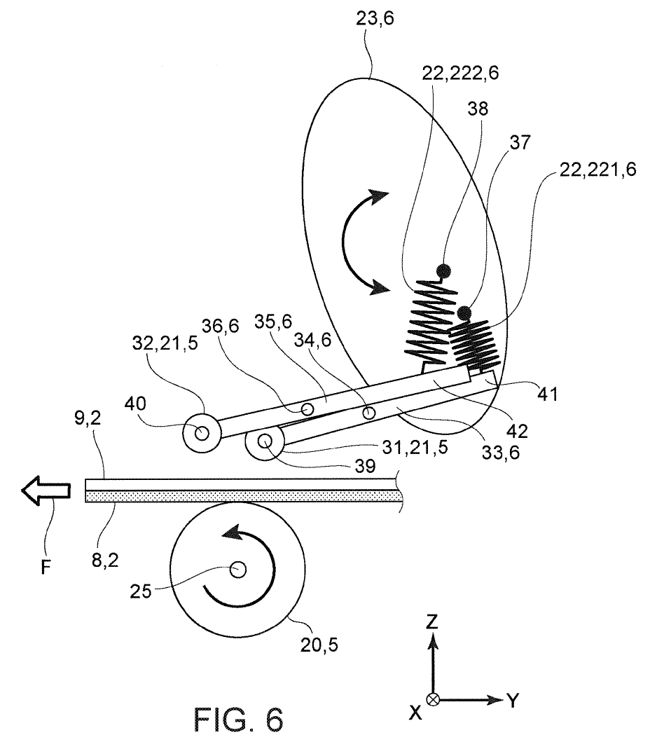

The cams 23 are further rotated to change the state from the state of FIG. 5 to the state of FIG. 6. In the state of FIG. 6, the spring lengths of the springs 221 and the springs 222 are further shortened, and neither set of springs are in the state of generating any pressing force P, and the swing members 33 and the swing members 35 are further swung to be in a state of separating the group of the first pressing rollers 31, 31... and the group of the second pressing rollers 32, 32... from the medium 2.

By reversing the above, that is, by rotating the cams 23 in the direction from the state of FIG. 6 to the state of FIG. 5 and further to the state of FIG. 4, the magnitude of the pressing force P can be adjusted so as to continuously increase.

In the present embodiment, the pressing roller 21 includes a group of a plurality of first rollers 31, 31... divided in the width direction (X direction), which intersects the transport direction F of the medium 2, and a group of second rollers 32, 32... disposed downstream of the group of first rollers 31, 31... in the transport direction F and so as to fill the gaps between the first rollers 31 in the width direction (X direction). That is, the pressing roller 21 is divided into a group of first rollers 31, 31... and a group of second rollers 32, 32.... Furthermore, the springs 221, 222 and the cams 23 are connected to the group of first rollers 31, 31... and the group of second rollers 32, 32... respectively. This eliminates the need to increase the roller diameter, thereby suppressing an increase in its size.

### THIRD EMBODIMENT

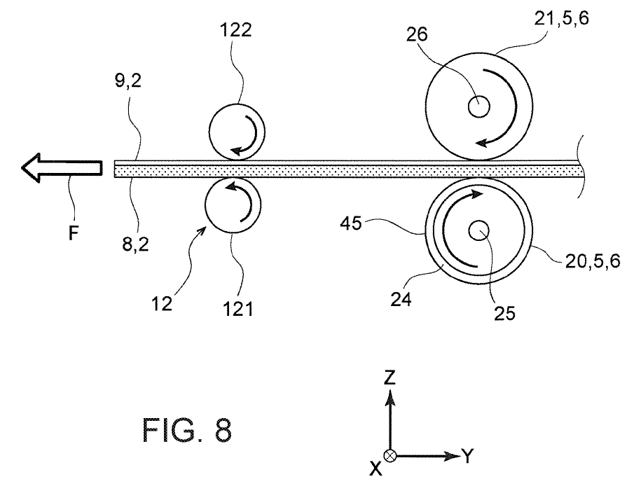

Next, a recording device 1 according to a third embodiment will be described with reference to FIG. 8. The same reference numerals are given to the same sections as those of the first embodiment, and description of that configuration and the corresponding effects will be omitted.

In the present embodiment, as described above, the transport roller 121 is provided disposed downstream of the pressing section 5 in the transport direction F and transports the medium 2.

The pressing section 5 includes the drive roller 20, which is connected to the drive section 19 and to which a rotational drive force is applied, and a pressing roller 21, which is driven to rotate by the movement of the medium 2 being nipped by the pair of rollers that includes the drive roller 20 and the pressing roller 21. The adjustment section 6 is configured to adjust the pressing force P by the drive roller 20 rotating in a reverse transport direction (+Y direction), which is the direction opposite to the transport direction F. That is, the pressing force P is adjusted by changing the rotation speed of the drive roller 20 in the reverse transport direction (+Y direction).

Further, in the present embodiment, the rotation speed of the drive roller 20 is set to be higher than the rotation speed of the transport roller 121, and the pressing force P can be efficiently adjusted.

In the present embodiment, the elastic member 24 is provided on the surface of the drive roller 20, and the surface of the elastic member 24 is provided with a low friction material 45. The low friction material 45 is not limited to a specific material, and a material generally considered as a low friction material may be used.

Further, as illustrated in FIG. 8, the diameter of the drive roller 20 is set to be larger than the diameter of the transport roller 121.

### Adjustment of pressing force

As illustrated in FIG. 8, the medium 2 is in a state of receiving a force directed in the direction (+Y direction) opposite to the transport direction F from the drive roller 20 in a state of receiving transport force in the transport direction F from the transport roller 121 of the transport section 12. The pressing force P increases by increases in rotation speed of the rotation of the drive roller 20 in the reverse direction (+Y direction), and the pressing force P decreases by decreases the rotation speed.

### Description of effects of third embodiment

(1) In the present embodiment, the transport roller 121 that transports the medium 2 is provided downstream of the pressing section 5. The pressing section 5 includes the drive roller 20, which is connected to the drive section 19 and to which a rotational drive force is applied, and a pressing roller 21, which is driven to rotate by the movement of the medium 2 that is nipped by the pair of rollers that includes the drive roller 20 and the pressing roller 21. Further, the adjustment section 6 adjusts the pressing force P by rotation of the drive roller 20 in the reverse transport direction (-Y direction), which is the direction opposite to the transport direction F. By this, the medium 2 is in a state of receiving a force directed in the direction opposite to the transport direction F from the drive roller 20 in a state of receiving a transport force in the transport direction F from the transport roller 121, and thus, it is possible to efficiently increase the pressing force P.

(2) In the present embodiment, the elastic member 24 is provided on the surface of the drive roller 20, and the surface of the elastic member 24 is provided with the low friction material 45. Since the surface of the drive roller 20 elastically deforms and presses the medium 2 in a squashed shape, the surface of the drive roller 20 is not in linear contact with the medium 2, but is in surface contact with the medium 2. By this, the medium 2 is in a state of being rubbed by receiving a force from the drive roller 20 in the direction opposite to the transport direction F, but the pressing force P can be adjusted in a state where receiving damage is suppressed by the elastic member 24 and the low friction material 45.

(3) In the present embodiment, the rotation speed of the drive roller 20 is set to be higher than the rotation speed of the transport roller 121. This makes it possible to efficiently adjust the pressing force P.

(4) In the present embodiment, the diameter of the drive roller 20 is larger than the diameter of the transport roller 121. By this, since the diameter is large, it is possible to secure a contact area with respect to the medium 2 and efficiently apply the pressing force P.

### OTHER EMBODIMENTS

The recording device 1 and the recording method according to the present disclosure basically have the configuration of the embodiments described above, but it is of course possible to perform changes, omissions, or the like of a partial configuration within a range not departing from the gist of the present disclosure.

What is claimed is:

1. A recording device comprising:
feeding section configured to feed a roll-shaped medium in a transport direction, the roll-shaped medium being formed by attaching a fabric to a support member having an adhesive surface;
recording section configured to perform recording on the medium;
pressing section that is positioned upstream of the recording section in the transport direction and that is configured to nip and press the medium moving in the transport direction; and
an adjustment section configured to adjust pressing force applied to the medium by the pressing section.

2. The recording device according to claim 1, wherein
the pressing section includes
a drive roller that is coupled to a drive section and that is applied with rotational drive force and
a pressing roller that is driven to rotate in accordance with rotation of the drive roller and
the adjustment section includes
a spring connected to the pressing roller and
a cam configured to adjust length of the spring.

3. The recording device according to claim 2, wherein
an elastic member is provided on a surface of the pressing roller.

4. The recording device according to claim 2, wherein
the pressing roller includes
a group of a plurality of first pressing rollers divided in a width direction that intersects the transport direction of the medium and
a group of second pressing rollers that are disposed downstream of the group of first pressing rollers in the transport direction and that are also disposed so as to fill gaps between the first pressing rollers in the width direction and
the spring and the cam are connected to each of the group of first pressing rollers and the group of second pressing rollers.

5. The recording device according to claim 1, further comprising:
a transport roller that is disposed downstream of the pressing section in the transport direction and that transports the medium, wherein
the pressing section includes
a drive roller that is coupled to a drive section and that is applied with rotational drive force and
a pressing roller that is driven to rotate by following movement of the medium nipped by a pair of rollers that include the pressing roller and the drive roller and
the adjustment section adjusts pressing force by rotating the drive roller in a reverse transport direction, which is a direction opposite to the transport direction.

6. The recording device according to claim 5, wherein
an elastic member is provided on a surface of the drive roller and
a low friction material is provided on a surface of the elastic member.

7. The recording device according to claim 5, wherein
rotation speed of the drive roller is higher than rotation speed of the transport roller.

8. The recording device according to claim 5, wherein
a diameter of the drive roller is larger than a diameter of the transport roller.

9. A recording method comprising:
feeding a roll-shaped medium in a transport direction, the roll-shaped medium including a fabric attached to a support member having an adhesive surface;
nipping and pressing, by a pressing section, the medium being fed;
adjusting a pressing force applied to the medium by the pressing section according to a type of the medium; and
recording on the medium by a recording section at a position downstream of the pressing section in the transport direction.
